(19) United States
(12) Patent Application Publication
(10) Pub. No.: US 2024/0105941 A1
(43) Pub. Date: Mar. 28, 2024

(54) Negative Electrode Material, Negative Electrode Plate, and Sodium Ion Battery

(71) Applicant: JIANGSU ZENERGY BATTERY TECHNOLOGIES CO., LTD., Jiangsu (CN)

(72) Inventors: Xiangxiang WANG, Jiangsu (CN); Yingnan DONG, Jiangsu (CN); Di WANG, Jiangsu (CN); Jizong ZHANG, Jiangsu (CN); Fengkai DONG, Jiangsu (CN)

(21) Appl. No.: 18/370,877

(22) Filed: Sep. 21, 2023

(30) Foreign Application Priority Data
Sep. 26, 2022 (CN) 202211171396.7

(51) Int. Cl. H01M 4/583; H01M 4/04; H01M 4/36; H01M 4/62; H01M 10/05

(52) U.S. Cl. CPC H01M 4/583; H01M 4/0419; H01M 4/0471; H01M 4/366; H01M 4/622; H01M 10/05; H01M 2004/027

(57) ABSTRACT

Disclosed is a negative electrode material and a preparation method therefor. The negative electrode material is a core-shell structure, and comprises a core layer formed by hard carbon, and a first carbonized layer, a carbon powder layer and a second carbonized layer which are sequentially coated at the outer side of the core layer. Further disclosed are a negative electrode plate prepared by the negative electrode material, and a sodium ion battery. The negative electrode material of the present disclosure can effectively improve the conductivity of a hard carbon material, thereby facilitating improvement of the performance such as initial Coulombic efficiency and cycle life of the sodium ion battery.

### TECHNICAL FIELD

The present disclosure relates to the technical field of sodium ion batteries, and in particular, to a negative electrode material, a negative electrode plate, and a sodium ion battery.

### BACKGROUND

Due to advantages of abundant sodium resources, wide spreading and low cost, etc., sodium ion batteries compensate resource scarcity, uneven distribution and high cost of lithium ion batteries, and have attracted wide attention in recent years. A negative electrode material of a sodium ion battery is mainly used as a main body for storing sodium, and intercalation and de-intercalation of sodium ions are realized in a charge-discharge process; therefore, the development of high-performance electrode materials is crucial for realizing the commercialization of sodium ion batteries.

A hard carbon material has good chemical stability, and is an ideal negative electrode active material for a sodium ion battery. However, this material is prone to have a point discharge effect; in addition, hard carbon itself has a high cost and an expensive price, and has disadvantages such as an excessively low initial efficiency and a low capacity. Graphite has higher conductivity than hard carbon, but graphite is difficult to be applied to sodium ion batteries.

Artificial graphite and natural graphite will produce a large amount of fine powder in a crushing process; the particle size of such fine powder is generally less than 1 μm, and such graphite fine powder has a large specific surface area, which will reduce the initial efficiency and capacity when used in lithium ion batteries. Therefore, a large amount of fine powder produced during crushing of the artificial graphite and natural graphite is generally taken as waste material, which reduces the utilization of the graphite. In order to improve the electrochemical performance of the graphite fine powder, asphalt and the graphite fine powder are often mixed and then treated at a high temperature, but this manner is also only applicable to artificial graphite of a lithium ion battery, and is difficult to be applied to a hard carbon material.

### SUMMARY

Some embodiments of the present disclosure aim to overcome the defects existing in the related art, and provide a negative electrode material of a sodium ion battery. The negative electrode material can effectively improve the conductivity of a hard carbon material, thereby facilitating improvement of the performance such as initial Coulombic efficiency and cycle life of the sodium ion battery.

In order to solve the described technical problem, some embodiments of the present disclosure provide the following technical solutions:

In a first aspect, some embodiments of the present disclosure provide a negative electrode material, wherein the negative electrode material is a core-shell structure, and comprises a core layer formed by hard carbon, and a first carbonized layer, a carbon powder layer and a second carbonized layer which are sequentially coated at the outer side of the core layer.

Further, a particle size D50 of the hard carbon is 3-15 μm and a specific surface area of the hard carbon is 5-200 m²/g.

Further, the carbon powder layer is composed of carbon powder, and the carbon powder comprises one or more of graphite fine powder, carbon nanotube fine powder, hard carbon fine powder, and soft carbon fine powder; and a particle size D50 of the carbon powder is 0.5-2 μm and a particle size D10 of the carbon powder is 0.1-0.5 μm.

Further, the second carbonized layer contains a sodium supplementing agent; and the sodium supplementing agent comprises one or more of Na₂SO₄, NaCl, NaNO3, Na₃PO₄, Na₂HPO₄, NaH₂PO₄, CH₃COONa, Na₂C₂O₄, NaClO₄, NaCF₃SO₃, F₂NaNO₄S₂, C₂F₆NaNO₄S₂ and Nal.

Further, a thickness of the first carbonized layer is 0.5-1.5 μm, a thickness of the carbon powder layer is 0.1-2 μm, and a thickness of the second carbonized layer is 0.5-2 μm.

Further, the proportion of total mass of the first carbonized layer, the carbon powder layer and the second carbonized layer in the total carbon content is 2-10%.

In a second aspect, some embodiments of the present disclosure provide a preparation method for the negative electrode material above, comprising the following steps:
pre-treating hard carbon with an acid solution;
providing a first glue solution, dispersing the pre-treated hard carbon in the first glue solution, and forming first particles by means of spray drying; and while performing spray drying, spraying a carbon powder onto the first particles, so that the carbon powder is adhered to and covers the surface of the first particles, to obtain second particles;
providing a second glue solution, dispersing the second particles in the second glue solution, and forming third particles by means of spray drying; and
under an inert atmosphere, performing carbonization treatment on the third particles, to obtain the negative electrode material.

Further, the pre-treatment temperature is 70-90° C., and the pre-treatment time is 12-20 h.

Further, the first glue solution and the second glue solution are both obtained by dissolving a polymer in water or an organic solvent, and the solid content thereof is 5-70%; and the polymer comprises one or more of polyvinylidene difluoride, polyvinylidene fluoride, Arabic gum, xanthan gum, guar gum, polyacrylic acid, styrene-butadiene rubber, carboxymethylcellulose, lithium carboxymethylcellulose, sodium carboxymethylcellulose, sodium alginate, polyethylene oxide, LA132, and sodium polyacrylate.

Further, when the pre-treated hard carbon is dispersed in the first glue solution, the temperature of the first glue solution is controlled to be 60-80° C. and the reaction time is controlled to be 6-10 h.

Further, a sodium supplementing agent is further added to the second glue solution, and the addition amount of the sodium supplementing agent is 0.01-0.1 g/mL.

Further, the temperature of the carbonization treatment is 650-1000° C., and the treatment time is 0.5-4 h.

In a third aspect, some embodiments of the present disclosure provide a negative electrode plate, comprising a negative electrode current collector and a negative electrode layer formed on the surface of the negative electrode current collector, wherein the negative electrode layer comprises the negative electrode material above.

In a fourth aspect, some embodiments of the present disclosure provide a sodium ion battery, comprising a positive electrode plate, a negative electrode plate, a separator and an electrolyte, wherein the separator is configured to separate the positive electrode plate from the negative electrode plate, and the negative electrode plate is the negative electrode plate as described above.

Compared with the related art, some embodiments of the present disclosure have the following beneficial effects:

1. In some embodiments of the present disclosure, the polymer and the carbon powder are coated on the surface and the interior of the hard carbon material, to form a negative electrode material having a multilayer-coated structure which takes the hard carbon as an inner core and takes the first carbonized layer, the carbon powder layer and the second carbonized layer as a shell; wherein the hard carbon is in close contact with the first carbonized layer, and the prepared composite hard carbon has a smaller specific surface area and a higher initial Coulombic efficiency.

2. The negative electrode material prepared in some embodiments of the present disclosure can effectively use the carbon powder to improve the conductivity of the hard carbon, reduce the manufacturing cost of the hard carbon, and have a high applicability to the hard carbon, thereby facilitating commercial application of the hard carbon.

3. In some embodiments of the present disclosure, by introducing the sodium supplementing agent into the carbonized layer at the outermost layer, irreversible consumption of sodium elements in the cycle process of the sodium ion battery is compensated, the initial Coulombic efficiency of the sodium ion battery is improved, the initial efficiency thereof is close to 100%, and a higher capacity is exhibited at the same time.

### BRIEF DESCRIPTION OF THE DRAWINGS

FIG. 1 is a structural diagram of an HC@CMC composite material prepared in some embodiments of the present disclosure;

FIG. 2 is an initial charge-discharge diagram of hard carbon; and

FIG. 3 is an initial charge-discharge diagram of an HC@CMC composite material;

in which: 1. Hard carbon; 2. First carbonized layer; 3. Carbon powder layer; 4. Second carbonized layer.

### DETAILED DESCRIPTION OF THE EMBODIMENTS

Unless otherwise defined, all technical and scientific terms used herein have the same meanings as those commonly understood by a person skilled in the technical field to which the present disclosure belongs. The terms used in the description of the present disclosure are for the purpose of describing particular embodiments only, and are not intended to limit the present disclosure. As used herein, the term “and/or” comprises any and all combinations of one or more associated listed items.

A hard carbon material is a negative electrode material widely used in sodium ion batteries, but has disadvantages such as poor conductivity, excessively low initial efficiency, and low capacity. In order to overcome various disadvantages of the hard carbon negative electrode material, some embodiments of the present disclosure provide a negative electrode material. By performing multilayer-coating on a hard carbon material, the described defects of hard carbon are overcome, and at the same time, manufacturing costs of hard carbon are reduced, and industrial application of carbon powder is also achieved.

Specifically, a preparation method for the negative electrode material provided in some embodiments of the present disclosure is as follows:
S1. pre-treating hard carbon with an acid solution;
S2. providing a first glue solution, dispersing the pre-treated hard carbon in the first glue solution, and forming first particles by means of spray drying; and before the first glue solution on the surface of the first particles is dried, spraying a carbon powder onto the first particles, so that the carbon powder is adhered to and covers the surface of the first particles, to obtain second particles;
S3. providing a second glue solution, dispersing the second particles in the second glue solution, and forming third particles by means of spray drying; and
S4. under an inert atmosphere, performing carbonization treatment on the third particles, to obtain the negative electrode material.

In step S1 of some embodiments of the present disclosure, the hard carbon (HC) may be either a biomass hard carbon or a polymer-cracked hard carbon; the morphology thereof may be a regular morphology or an irregular morphology. The hard carbon has a particle size D50 of preferably 3-15 μm, and more preferably 5-12 μm. The hard carbon has a specific surface area of preferably 5-200 m²/g, and more preferably 5-80 m²/g.

In step S1 of some embodiments of the present disclosure, the hard carbon is pre-treated with an acid solution, so that the surface and inner pores of the hard carbon can be activated to generate more active functional groups. In subsequent process of polymer coating, the presence of these active functional groups can make the polymer more closely bonded to the surface of the hard carbon, thereby improving the stability of a coating layer. The acid solution used is preferably a strong acid, which can activate the hard carbon better to produce more active functional groups. The acid solution may be an inorganic acid or an organic acid. As an inorganic acid, the acid solution may be common strong acids, such as nitric acid, sulfuric acid, phosphoric acid, etc.; and as an organic acid, the acid solution may be oxalic acid, sulfonic acid, malonic acid, etc.

The pre-treatment is specifically: adding the hard carbon into the acid solution, stirring same, and then taking same out for drying. Here, the temperature of the acid solution is controlled to be preferably 70-90° C., e.g. 70° C., 75° C., 80° C., 85° C., 90° C. or the like. The stirring time is preferably 12-20 h, e.g. 12 h, 13 h, 14 h, 15 h, 16 h, 17 h, 18 h, 19 h, 20 h, etc.

In step S2 of some embodiments of the present disclosure, the first glue solution is obtained by dissolving a polymer in a solvent. Specifically, the polymer is added to the solvent, the polymer is dissolved by stirring, and a uniform and stable glue solution with a certain viscosity is formed. The polymer includes but is not limited to one or more of polyvinylidene difluoride, polyvinylidene fluoride, Arabic gum, xanthan gum, guar gum, polyacrylic acid, styrene-butadiene rubber, carboxymethylcellulose, lithium carboxymethylcellulose, sodium carboxymethylcellulose, sodium alginate, polyethylene oxide, LA132, sodium polyacrylate or analogues/modifying substances thereof. The solvent may be selected according to the type of the polymer, and may be water or an organic solvent. With regard to the organic solvent, common organic solvents in the art can be selected, including but not limited to methanol, ethanol, acetone, etc. In some embodiments of the present disclosure, the first glue solution needs to have a certain viscosity and good fluidity, and the solid content thereof is preferably controlled to be 5-70%, for example, 5%, 10%, 20%, 30%, 40%, 50%, 60%, 70%, etc. According to different types of the glue solution, different solid contents are respectively controlled, so that the first glue solution has appropriate viscosity and fluidity.

In step S2 of some embodiments of the present disclosure, when the pre-treated hard carbon is dispersed in the first glue solution, the temperature of the first glue solution is preferably controlled to be 60-80° C. Such a heating temperature enables the first glue solution to have good fluidity, and can make the first glue solution quickly diffuse into the hard carbon, and effectively fill inner pores of the hard carbon; in addition, under a heating and stirring condition, the polymer can be better bonded to the functional groups on the surface and inner pores of the hard carbon, so as to form a stable integrated coating structure. Preferably, the stirring and dispersing time of the hard carbon in the first glue solution is 6-10 h, thereby ensuring that the hard carbon is in sufficient contact with the polymer in the first glue solution, so that the functional groups on the surface of the hard carbon sufficiently react with the polymer.

In step S2 of some embodiments of the present disclosure, after the hard carbon is sufficiently dispersed in the first glue solution, the first glue solution containing hard carbon is spray dried to form first particles. The first particles are spherical particles, the inner core thereof is the hard carbon, and the surface of the hard carbon has a coating layer formed by the first glue solution. The reason of using spray drying to prepare particles is: the processing steps are simple, a large amount of particles with good degree of sphericity can be quickly prepared, and at the same time, the polymer coating layer on the surface of the particles is complete and has good uniformity. Parameters such as speed, temperature, and wind speed of the spray drying need to be set rationally, so as to ensure that when the first particles are obtained by spray drying, the first glue solution on the surface thereof is not quickly and completely dried, thereby facilitating adhesion of carbon powder in a subsequent process.

In step S2 of some embodiments of the present disclosure, while spray drying the first glue solution containing hard carbon, a carbon powder is sprayed onto the first particles formed; and as the first glue solution on the surface of the first particles is not completely dried and has a certain viscosity, the sprayed carbon powder can be well adhered to and coated on the surface of the first particles, to form a uniformly-coated carbon powder layer, thereby obtaining second particles denoted as HC@M.

In some embodiments of the present disclosure, the carbon powder includes but is not limited to, one or more of graphite fine powder, carbon nanotube fine powder, hard carbon fine powder, and soft carbon fine powder. Such fine powder is fine dust produced during crushing and processing of products such as graphite, hard carbon and carbon nanotubes, and has a large specific surface area. Particle powder of such small particles is not conducive to lithium storage, and will increase the formation of useless SEI films. When such particle powder is used in a lithium ion battery, the initial efficiency and capacity of the lithium ion battery will be reduced; therefore, such particle powder is difficult to be directly used in the industry of lithium batteries, and is generally discarded as waste material. However, such carbon powder has good conductivity; in some embodiments of the present disclosure, by spray drying, such carbon powder is adhered to the surface of hard carbon particles to form a carbon powder layer, which not only realizes industrial application of the carbon powder waste material, but also improves the conductivity of the hard carbon, thereby reducing the manufacturing cost of the hard carbon material. Preferably, the carbon powder is selected as graphite fine powder. In some embodiments of the present disclosure, the particle size of the carbon powder is not limited, as long as a good coating layer can be formed on the surface of the hard carbon. Preferably, the carbon powder has a particle size D50 of 0.5-2 μm and a particle size D10 of 0.1-0.5 μm.

In the second particles HC@M, the adhesion of the carbon powder is not tight enough, and the carbon powder is prone to fall off during the subsequent preparation of a battery slurry. Therefore, in some embodiments of the present disclosure, the surface of the second particles HC@M also needs to be continuously coated to form a protective layer, so as to prevent the carbon powder layer from falling off.

In step S3 of some embodiments of the present disclosure, the preparation method of the second glue solution is the same as that of the first glue solution. Then, the obtained second particles HC@M are added to the second glue solution and stirred, so that the second particles HC@M are sufficiently dispersed in the second glue solution. Next, third particles are formed by spray drying and denoted as HC@MM. In the third particles HC@MM, the surface thereof is a coating layer formed by solidifying the second glue solution, which achieves the functions of protecting the carbon powder layer and preventing same from falling off.

In a preferred embodiment, a certain amount of sodium supplementing agent is also added in the preparation process of the second glue solution, so as to compensate irreversible consumption of sodium elements of the hard carbon negative electrode in a cycle process of the sodium ion battery, thereby increasing the initial Coulombic efficiency of the sodium ion battery. The sodium supplementing agent can be selected from common sodium salts, including but not limited to one or more of Na₂SO₄, NaCl, NaNO₃, Na₃PO₄, Na₂HPO₄, NaH₂PO₄, CH₃COONa, Na₂C₂O₄, NaClO₄, NaCF₃SO₃, F₂NaNO₄S₂, C₂F₆NaNO₄S2 and Nal. Taking 100 mL of second glue solution as an example, an appropriate addition amount of the sodium supplementing agent is 1-10 g, for example, 1 g, 2 g, 3 g, 4 g, 5 g, 6 g, 7 g, 8 g, 9 g, 10 g. After the sodium supplementing agent is added, the sodium supplementing agent is sufficiently dispersed in the second glue solution by stirring, so as to ensure the distribution uniformity of the sodium supplementing agent in the third particles HC@MM.

By the described steps, the hard carbon is coated by multiple layers, which results in conductivity degradation; therefore, carbonization treatment needs to be further performed, so that polymers in the first glue solution and the second glue solution are carbonized to form carbonized layers, thereby improving the conductivity of the material.

In step S4 of some embodiments of the present disclosure, under an inert atmosphere, carbonization treatment is performed on the third particles, to obtain a multilayer-coated hard carbon material denoted as HC@CMC. The inert atmosphere comprises one or more of a nitrogen atmosphere and an inert gas atmosphere. The temperature of the carbonization treatment is preferably 650-1000° C., for example, 650° C., 700° C., 750° C., 800° C., 850° C., 900° C., 950° C., 1000° C.; and the carbonization treatment time is preferably 0.5-4 h, for example, 0.5 h, 1 h, 1.5 h, 2 h, 2.5 h, 3 h, 3.5 h, 4 h.

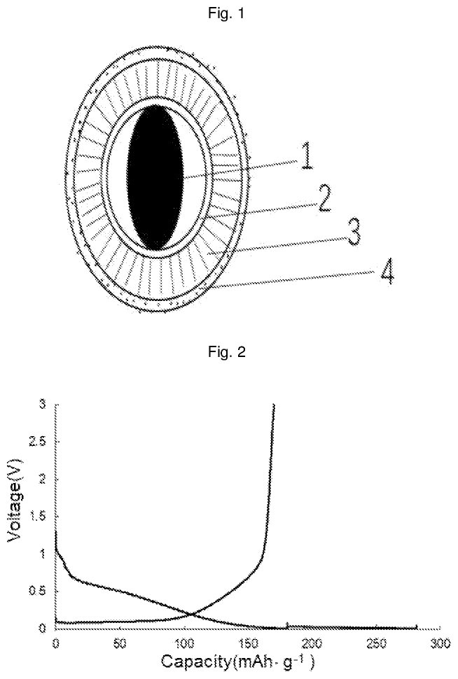

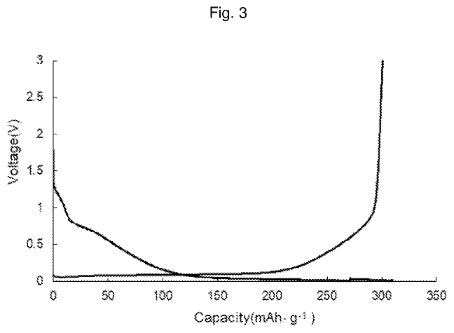

Please refer to FIG. 1, the multilayer-coated hard carbon material HC@CMC prepared in some embodiments of the present disclosure presents a relatively perfect spherical structure, and comprises a core layer formed by hard carbon 1, and a first carbonized layer 2, a carbon powder layer 3 and a second carbonized layer 4 which are sequentially coated at the outer side the core layer. The first carbonized layer 2 and the second carbonized layer 4 are respectively formed by carbonizing polymers in the first glue solution and the second glue solution; and in a preferred embodiment, the second carbonized layer 4 further contains a certain amount of sodium supplementing agent.

In some embodiments of the present disclosure, the thickness of the first carbonized layer is preferably 0.5-1.5 μm, for example, 0.5 μm, 0.6 μm, 0.7 μm, 0.8 μm, 0.9 μm, 1.0 μm, 1.1 μm, 1.2 μm, 1.3 μm, 1.4 μm, 1.5 μm; the thickness of the carbon powder layer is preferably 0.1-2 μm, for example, 0.1 μm, 0.2 μm, 0.3 μm, 0.4 μm, 0.5 μm, 0.6 μm, 0.7 μm, 0.8 μm, 0.9 μm, 1.0 μm, 1.1 μm, 1.2 μm, 1.3 μm, 1.4 μm, 1.5 μm, 1.6 μm, 1.7 μm, 1.8 μm, 1.9 μm, 2.0 μm; and the thickness of the second carbonized layer is preferably 0.5-2 μm, for example, 0.5 μm, 0.6 μm, 0.7 μm, 0.8 μm, 0.9 μm, 1.0 μm, 1.1 μm, 1.2 μm, 1.3 μm, 1.4 μm, 1.5 μm, 1.6 μm, 1.7 μm, 1.8 μm, 1.9 μm, 2.0 μm.

In some embodiments of the present disclosure, the proportion of total mass of the first carbonized layer, the carbon powder layer and the second carbonized layer in the total carbon content is 2-10%, for example, 2%, 3%, 4%, 5%, 6%, 7%, 8%, 9%, and 10%. The “total carbon content” herein refers to the total mass of the hard carbon, the first carbonized layer, the carbon powder layer, and the second carbonized layer.

The multilayer-coated hard carbon material HC@CMC prepared in some embodiments of the present disclosure can be further prepared into a sodium ion battery negative electrode plate. An exemplary preparation method is: preparing an electrode slurry by HC@CMC, a binder and a conductive agent at a certain ratio, then coating same on a negative electrode current collector, and after drying and compressing, obtaining a sodium ion battery negative electrode plate.

The binder above can be selected from binders commonly used in sodium ion batteries, including but not limited to one or more of polyacrylonitrile, polyvinylidene fluoride, polyvinyl alcohol, sodium carboxymethylcellulose, polymethacryloyl, polyacrylic acid, sodium polyacrylate, polyacrylamide, polyamide, polyimide, polyacrylate, styrene-butadiene rubber, sodium alginate, chitosan, polyethylene glycol, guar gum and the like.

The conductive agent above can be selected from conductive agents commonly used in sodium ion batteries, including but not limited to one or more of conductive carbon black, carbon nanotube, graphene, etc.

Some embodiments of the present disclosure further provide a sodium ion battery, comprising a positive electrode plate, a negative electrode plate, a separator and an electrolyte, wherein the separator is configured to separate the positive electrode plate from the negative electrode plate, and the negative electrode plate is a sodium ion battery negative electrode plate prepared by the multilayer-coated hard carbon material HC@CMC. An exemplary preparation method for a battery may be: winding the negative electrode plate above, a separator and a positive electrode plate to obtain a cell; installing the cell into a battery housing; after vacuum drying, injecting an electrolyte into the battery shell; and after encapsulation, standing still, formation, and capacity grading, obtaining a sodium ion battery.

Hereinafter, the present disclosure will be further described with reference to the specific embodiments, so that a person skilled in the art could better understand the present disclosure and implement same, but the embodiments listed are not intended to limit the present disclosure.

Unless specially illustrated, experimental methods used in the following examples are all conventional methods; and unless specially illustrated, materials, reagents and the like used can all be obtained commercially.

### Example 1

The present example provides a preparation method for a negative electrode material of a sodium ion battery, comprising the following steps:
(1) formulating 1 mol/L of HNO₃ solution, pouring 200 g of hard carbon into 400 ml of acid solution, and controlling the temperature of the acid solution to be 80° C. and the stirring time to be 15 h, to obtain pre-treated hard carbon;
(2) taking 600 mL of solvent N-methyl pyrrolidone (NMP), adding polyvinylidene fluoride (PVDF), and stirring until uniform dispersion to form a stable glue solution; wherein the glue solution contains 6 g of PVDF per 100 ml, so as to obtain a first glue solution;
(3) taking 100 g of hard carbon, stirring and dispersing same into 300 ml of the first glue solution, controlling the temperature of the glue solution to be 80° C. and the constant temperature time to be 4 h, then performing spray drying, and spraying graphite powder while performing spray drying, to obtain HC@M;
(4) taking 100 ml of the first glue solution, adding 5 g of sodium oxalate, and after dispersing, obtaining a second glue solution;
(5) taking 50 g of HC@M, stirring and dispersing same into 50 ml of the second glue solution, and after spray drying, preparing same to HC@MM for standby use; and
(6) taking 50 g of HC@MM and performing carbonization treatment under an inert gas atmosphere, wherein the carbonization treatment temperature is 700° C. and the treatment time is 2 h, so as to obtain multilayer-coated hard carbon HC@CMC. After the outer layer of the polymer is carbonized, the carbon in the outer layer occupies 6% of the total carbon content.

### Example 2

Example 2 differs from Example 1 in that: in step (6), the carbonization treatment temperature is 800° C., and after the outer layer of the polymer is carbonized, the carbon in the outer layer 5% of the total carbon content.

### Example 3

Example 3 differs from Example 1 in that: in step (6), the carbonization treatment temperature is 900° C., the treatment time is 3 h, and after the outer layer of the polymer is carbonized, the carbon in the outer layer 5% of the total carbon content.

### Example 4

Example 4 differs from Example 3 in that: in step (4), the addition amount of a sodium supplementing agent is 8 g.

### Example 5

Example 5 differs from Example 1 in that: in step (4), the addition amount of a sodium supplementing agent is 10 g; and in step (6), the carbonization treatment temperature is 900° C., the treatment time is 3 h.

### Example 6

Example 6 differs from Example 1 in that: in step (3), taking 100 g of hard carbon, and stirring and dispersing same into 500 ml of the first glue solution; in step (5), taking 50 g of HC@M, and stirring and dispersing same into 150 ml of the second glue solution; and in step (6), after the outer layer of the polymer is carbonized, the carbon in the outer layer 8.5% of the total carbon content.

### Comparative Example 1

Hard carbon is used as a negative electrode material.

### Comparative Example 2

Comparative Example 2 differs from Example 1 in that: not performing steps (4) and (5); and in step (6), obtaining single layer-coated hard carbon HC@C; and after the outer layer of the polymer is carbonized, the carbon in the outer layer 4.5% of the total carbon content.

### Comparative Example 3

Comparative Example 3 differs from Example 1 in that: not performing step (3); in step (5), taking 50 g of pre-treated hard carbon and adding same into 50 ml of the second glue solution, and drying same for standby use; in step (6), obtaining single layer-coated hard carbon HC@C; and after the outer layer of the polymer is carbonized, the carbon in the outer layer 1.5% of the total carbon content.

Performance Test

At a mass ratio of negative electrode material:conductive carbon black:PVDF binder=8:1:1, mixing the negative electrode material, the conductive carbon black and the PVDF binder; taking NMP as a solvent, after slurry mixing, coating same on an aluminum foil; performing vacuum drying at 100° C. and performing rolling, then obtaining a negative electrode plate. Then, assembling the negative electrode plate, Counter Electrode plate (metallic lithium), an electrolyte (1 mol/L of NaPF₆ and a solvent of EC:DEC=1:1) and a glass fiber separator into a battery.

Performing charge-discharge experiments on the obtained battery in an environment of 25±2° C., wherein the charge-discharge voltage is 5 mV-3 V, the theoretical capacity of the material is 300 mAh-g-1, the data recording sampling point is 1 s/time, and the following performances are tested.

1. Initial Coulombic Efficiency:

First, the battery is placed in an environment of 25±2° C. and stands still and is discharged for 8 h, and then discharged to 0.005 V at a constant current of 0.05 C, wherein the obtained capacity is recorded as a 0.05 C charge capacity; then the battery stands still for 5 min, and is charged to a voltage of 3.0V at a constant current of 0.1 C, wherein the obtained capacity is recorded as a 0.1 C discharge capacity; finally stop operation, and the initial Coulombic efficiency is 0.05C charge capacity/0.1 C discharge capacity.

2. Discharge Capacity Corresponding to a Current Density of 0.2 C:

First, the battery is placed in an environment of 25±2° C. and stands still and is discharged for 8 h, and then discharged to 0.005 V at a constant current of 0.05 C; next the battery stands still for 5 min, then is charged to a voltage of 3.0 V at a constant current of 0.2 C; then the battery stands still for 5 min, and then discharged to 0.005 V at a constant current of 0.2 C, wherein the obtained capacity is a discharge capacity corresponding to 0.2 C; finally stop operation, and the second discharge capacity is recorded as a discharge capacity corresponding to 0.2 C.

3. Discharge Capacity Corresponding to Discharge Capacity Corresponding to 1 C (Embodying Rate Capability)

First, the battery is placed in an environment of 25±200 and stands still and is discharged for 8 h, and then discharged to 0.005 V at a constant current of 1 C; next the battery stands still for 5 min, then is charged to a voltage of 3.0 V at a constant current of 1 C; then the battery stands still for 5 min, and then discharged to 0.005 V at a constant current of 1 C, wherein the obtained capacity is a discharge capacity corresponding to 1 C; finally stop operation, and the second discharge capacity is recorded as a discharge capacity corresponding to 1 C.

4. 0.2 C Capacity Retention Ratio after 50 Cycles

First, the battery is placed in an environment of 25±200 and stands still and is discharged for 8 h, and then discharged to 0.005 V at a constant current of 0.2 C; next the battery stands still for 5 min, then is charged to a voltage of 3.0 V at a constant current of 0.2 C; the cycle above repeats for 50 times, and finally stop operation, and the first and the 50-th discharge capacities are recorded, and the capacity retention ratio is the 50th discharge capacity/the first discharge capacity.

TABLE 1
Performance test data of batteries in Examples and Comparative Examples

| | Initial | Capacity | Capacity | Capacity |
|---|---|---|---|---|
| | Coulombic | Corresponding | Corresponding | retention ratio |
| | Efficiency | to 0.2 C | to 1 C | after 50 |
| | (%) | (mAh · g⁻¹) | (mAh · g⁻¹) | cycles |
| Example 1 | 97.13 | 301.10 | 285.25 | 97.17 |
| Example 2 | 97.04 | 300.82 | 286.10 | 96.86 |
| Example 3 | 96.42 | 298.90 | 286.25 | 97.36 |
| Example 4 | 97.08 | 300.94 | 285.6 | 96.39 |
| Example 5 | 97.43 | 302.03 | 282.16 | 92.26 |
| Example 6 | 97.38 | 301.38 | 284.35 | 95.54 |
| Comparative | 60.64 | 170.4 | 158.12 | 93.71 |
| Example 1 | | | | |
| Comparative | 82.65 | 232.25 | 221.49 | 94.67 |
| Example 2 | | | | |
| Comparative | 84.22 | 236.65 | 224.87 | 94.06 |
| Example 3 | | | | |

It can be determined from the results in Table 1 that, compared with Comparative Examples 1-3, the batteries of Examples 1-6 use the multilayer-coated hard carbon material as the negative electrode active material, and thus have significant improvements in initial Coulombic efficiency, capacities corresponding to 0.2 C and 1 C, and capacity retention ratio after 50 cycles. The initial Coulombic efficiencies of the batteries in Examples 1-6 all exceed 96%, which is much higher than that of the battery using a hard carbon negative electrode in Comparative Example 1, and is also obviously higher than that of the batteries using a single layer-coated hard carbon negative electrode in Comparative Examples 2-3. In Example 5, since more sodium supplementing agent is added to the negative electrode material, it shows the highest initial Coulombic efficiency, reaching 97.43%.

Regarding the batteries of Examples 1-6, capacities corresponding to 0.2 C and 1 C are respectively higher than 298 mAh-g⁻¹ and 280 mAh-g⁻¹, and are also significantly higher than those in Comparative Examples 1-3.

The batteries of Examples 1-6 also show certain advantages in terms of capacity retention ratio after 50 cycles. The capacity retention ratios after 50 cycles are all lower than 95% in Comparative Examples 1-3, but are higher than 95% in Examples 1-4 and 6; particularly, in Examples 1 and 3, the capacity retention ratios after 50 cycles both exceed 97%, which shows excellent cycle stability. As for the battery of Example 5, as the carbonization temperature of the negative electrode material is low, the battery has a poor cycle performance, and the capacity retention ratio after 50 cycles is 92.26%, which is slightly lower than those of Comparative Examples 1-3.

The embodiments above are only preferred embodiments for sufficiently describing some embodiments of the present disclosure, and the scope of protection of some embodiments of the present disclosure is not limited thereto. Any equivalent replacement or transformation made by a persons skilled in the art based on some embodiments of the present disclosure shall belong to the scope of protection of the present disclosure. The scope of protection of the present disclosure shall be subject to the appended claims.

What is claimed is:

1. A negative electrode material, wherein the negative electrode material is a core-shell structure, and comprises a core layer formed by hard carbon, and a first carbonized layer, a carbon powder layer and a second carbonized layer which are sequentially coated at the outer side of the core layer.

2. The negative electrode material according to claim 1, wherein a particle size D50 of the hard carbon is 3-15 μm and a specific surface area of the hard carbon is 5-200 m²/g.

3. The negative electrode material according to claim 1, wherein the carbon powder layer is composed of carbon powder, and the carbon powder comprises one or more of graphite fine powder, carbon nanotube fine powder, hard carbon fine powder, and soft carbon fine powder; and a particle size D50 of the carbon powder is 0.5-2 μm and a particle size D10 of the carbon powder is 0.1-0.5 μm.

4. The negative electrode material according to claim 1, wherein the second carbonized layer contains a sodium supplementing agent; and the sodium supplementing agent comprises one or more of Na₂SO₄, NaCl, NaNO3, Na₃PO₄, Na₂HPO₄, NaH₂PO₄, CH₃COONa, Na₂C₂O₄, NaClO₄, NaCF₃SO₃, F₂NaNO₄S₂, C₂F₆NaNO₄S2 and Nal.

5. The negative electrode material according to claim 1, wherein a thickness of the first carbonized layer is 0.5-1.5 μm, a thickness of the carbon powder layer is 0.1-2 μm, and a thickness of the second carbonized layer is 0.5-2 μm.

6. The negative electrode material according to claim 1, wherein the proportion of total mass of the first carbonized layer, the carbon powder layer and the second carbonized layer in the total carbon content is 2-10%.

7. A preparation method for a negative electrode material, comprising the following steps:
pre-treating hard carbon with an acid solution;
providing a first glue solution, dispersing the pre-treated hard carbon in the first glue solution, and forming first particles by means of spray drying; and while performing spray drying, spraying a carbon powder onto the first particles, so that the carbon powder is adhered to and covers the surface of the first particles, to obtain second particles;
providing a second glue solution, dispersing the second particles in the second glue solution, and forming third particles by means of spray drying; and
under an inert atmosphere, performing carbonization treatment on the third particles, to obtain the negative electrode material.

8. The preparation method for a negative electrode material according to claim 7, wherein the pre-treatment temperature is 70-90° C., and the pre-treatment time is 12-20 h.

9. The preparation method for a negative electrode material according to claim 7, wherein the first glue solution and the second glue solution are both obtained by dissolving a polymer in water or an organic solvent, and the solid content thereof is 5-70%; and
the polymer comprises one or more of polyvinylidene difluoride, polyvinylidene fluoride, Arabic gum, xanthan gum, guar gum, polyacrylic acid, styrene-butadiene rubber, carboxymethylcellulose, lithium carboxymethylcellulose, sodium carboxymethylcellulose, sodium alginate, polyethylene oxide, LA132, and sodium polyacrylate.

10. The preparation method for a negative electrode material according to claim 7, wherein when the pre-treated hard carbon is dispersed in the first glue solution, the temperature of the first glue solution is controlled to be 60-80° C. and the reaction time is controlled to be 6-10 h.

11. The preparation method for a negative electrode material according to claim 9, wherein a sodium supplementing agent is further added to the second glue solution, and the addition amount of the sodium supplementing agent is 0.01-0.1 g/mL.

12. The preparation method for a negative electrode material according to claim 7, wherein the temperature of the carbonization treatment is 650-1000° C., and the carbonization treatment time is 0.5-4 h.

13. A negative electrode plate, comprising a negative electrode current collector and a negative electrode layer formed on the surface of the negative electrode current collector, wherein the negative electrode layer comprises the negative electrode material according to claim 1.

14. A sodium ion battery, comprising a positive electrode plate, a negative electrode plate, a separator and an electrolyte, wherein the separator is configured to separate the positive electrode plate from the negative electrode plate, wherein the negative electrode plate is the negative electrode plate according to claim 13.

15. The negative electrode plate according to claim 13, wherein a particle size D50 of the hard carbon is 3-15 μm and a specific surface area of the hard carbon is 5-200 m²/g.

16. The negative electrode plate according to claim 13, wherein the carbon powder layer is composed of carbon powder, and the carbon powder comprises one or more of graphite fine powder, carbon nanotube fine powder, hard carbon fine powder, and soft carbon fine powder; and a particle size D50 of the carbon powder is 0.5-2 μm and a particle size D10 of the carbon powder is 0.1-0.5 μm.

17. The negative electrode plate according to claim 13, wherein the second carbonized layer contains a sodium supplementing agent; and the sodium supplementing agent comprises one or more of Na₂SO₄, NaCl, NaNO3, Na₃PO₄, Na₂HPO₄, NaH₂PO₄, CH₃COONa, Na₂C₂O₄, NaClO₄, NaCF₃SO₃, F₂NaNO₄S₂, C₂F₆NaNO₄S2 and Nal.

18. The negative electrode plate according to claim 13, wherein a thickness of the first carbonized layer is 0.5-1.5 μm, a thickness of the carbon powder layer is 0.1-2 μm, and a thickness of the second carbonized layer is 0.5-2 μm.

19. The negative electrode plate according to claim 13, wherein the proportion of total mass of the first carbonized layer, the carbon powder layer and the second carbonized layer in the total carbon content is 2-10%.
